(19) United States
(12) Patent Application Publication
(10) Pub. No.: US 2026/0343527 A1
(43) Pub. Date: Oct. 29, 2026

(54) SYSTEM AND METHOD FOR SHARING RESOURCES ON COMMUNICATION DEVICES

(71) Applicant: Telefonaktiebolaget LM Ericsson (publ), Stockholm (SE)

(72) Inventors: Jan CHRISTOFFERSSON, LULEÅ (SE); Mårten ERICSON, GAMMELSTAD (SE); Stefan WÄNSTEDT, LULEÅ (SE)

(73) Assignee: Telefonaktiebolaget LM Ericsson (publ), Stockholm (SE)

(21) Appl. No.: 19/487,840

(22) PCT Filed: May 31, 2023
(86) PCT No.: PCT/EP2023/064543

§ 371 Date: Nov. 25, 2025

(51) Int. Cl. H04W 72/121; H04W 72/21

(52) U.S. Cl. CPC H04W 72/121; H04W 72/21

(57) ABSTRACT

A method at a first communication device for sharing resources with a second communication device, the method comprise setting up a connection between the two communication devices, negotiating in response to becoming aware of that resource sharing is required between the two communication devices, on resource sharing between the two communication devices, notifying results of the negotiation to a network node, receiving information on at least one configuration from the network node, wherein the at least one configuration is, at least partly based on the results of the negotiation, reconfiguring the first communication device based on the information on at least one configuration and sharing resources based on the executed reconfiguration.

### TECHNICAL FIELD

The present disclosure refers to a method and system for sharing resources on communication devices, a communication device and a network node adapted for sharing resource.

### BACKGROUND

A general problem with low-cost IoT devices is that if too much manual labour is required for deploying and operating such devices, these devices will not remain low-cost. Usually, such low-cost devices have a limited set of capabilities, such as e.g. lower bit rate or limited antenna capabilities.

Consequently, if the deployed reduced capability devices suddenly need to perform in other use cases than the ones they have been designed for, or temporarily require increased capabilities, such as e.g., to send data more frequently and with much higher bit rate, there is a desire to increase capability while cost can be kept as low as possible. If this type of simple connected devices are allowed to share hardware with other devices, located in proximity, e.g. one device can use one lor more antennas from one or more other devices for a limited period of time, this may result in that this fairly simple device could temporarily be much more capable.

Most smartphones today can use different sets of capabilities, e.g. most high-end smartphones can use 3G, 4G or 5G capabilities, depending on demand. However, the switch from one set of capabilities to another is not very fast and practically involves establishing a new connection to another RAT (Radio access technology). Even within a RAT, different devices may have different capabilities, depending on the subscription, device/NB hardware and available spectrum. By way of example, a first communication device is configured to accomplish a task for which it normally has sufficient resources, but for a limited time interval the first communication device has a demand for extra resources for carrying out another specific, task. In such a situation two or more other communication devices can share resources with the first communication device. However, only involving the communication devices in such a resource sharing procedure, may result in network inefficiency, especially if a large number of communication devices are sharing resources at the same time. It is therefore a desire to allow communication devices to share resources with each other without deteriorating network performance.

### SUMMARY

It is an object of the present document to address, or at least alleviate, at least some of the problems described above.

According to one aspect, a method at a first communication device for sharing resources with a second communication device is suggested. The method comprises setting up a connection between the two communication devices, negotiating, in response to becoming aware of that resource sharing is required between the two communication devices, on resource sharing between the two communication devices, notifying results of the negotiation to a network node, receiving information on at least one configuration from the network node, wherein the at least one configuration is, at least partly, based on the results of the negotiation, reconfiguring the first communication device, based on the information on at least one configuration and sharing resources, based on the executed reconfiguration.

According to one embodiment, the negotiation comprises an exchange of capabilities between the communication devices.

According to one embodiment, the result of the negotiation comprises capabilities of at least the first communication device.

According to one embodiment, the result of the negotiation comprises information on at least one of: at least one resource to be shared and a time interval for resource sharing.

According to one embodiment, the notification of results further comprises details of a sharing plan.

According to one embodiment, the information on at least one configuration is set to be valid for at least one of: a specific time, a number of DRX cycles and a duration of an ongoing session.

According to one embodiment, information on which configuration the communication device will use from now on is provided to the network node.

According to one embodiment, the reconfiguring further comprises selecting one of the at least one received configuration.

According to one embodiment, the reconfiguring further comprises providing information on which configuration the communication device will use to the network node.

According to one embodiment, the received information further comprise information on which uplink channel to use when providing information to the network node on which reconfiguration to use.

According to one embodiment, the uplink channel is a physical uplink control channel (PUCCH).

According to one embodiment, the notifying comprises a consolidating of the results on the negotiating on the resource sharing between the two communication devices.

According to another aspect, a network node for assisting a first communication device and a second communication device, sharing resources with each other, is suggested. The method comprises receiving results on a negotiation on resource sharing between the two communication devices, determining at least one configuration, based, at least partly, on the provided results and providing information on the at least one determined configuration to at least one of the communication devices.

According to one embodiment, the result of the negotiation is received from one of the communication devices, as consolidated results on the negotiation.

According to one embodiment, receiving the results of the negotiation comprises providing capabilities of both the communication devices.

According to one embodiment, the at least one configuration is determined to be valid on a temporary basis.

According to one embodiment, the at least one configuration is determined to be valid for at least one of: a specific time interval, a number of DRX cycles and a session.

According to one embodiment, the determining of the at least one configuration is further based on at least one of information on use of or estimated use of: Radio Access Technologies (RATs), bandwidth, battery and number of antennas.

According to one embodiment, providing results on the negotiation further comprises providing information on capabilities of the communication devices.

According to one embodiment, the determining at least one configuration is based on at least one of requirements of: energy efficiency, bitrate and latency.

According to one embodiment, further information on any of the communication devices is requested, prior to determining any configuration.

According to one embodiment, further information associated with at least one of the resources to be shared is requested.

According to one embodiment, providing the information on the at least one configuration include providing details on a sharing plan.

According to one embodiment, determining the information on the at least one configuration is based on at least one of: aligning paging and DRX configurations.

According to one embodiment, information from at least one of the communication devices, indicating which configuration is presently active or about to become active, is received.

According to one embodiment, a physical downlink control channel (PDCCH) is used for providing information on which configuration to use.

According to another aspect, a first communication device for sharing resources with a second communication device is suggested. The first communication being configured to set up a connection between the two communication devices, negotiating on resource sharing between the two communication devices, in response to becoming aware of that resource sharing is required between the two communication devices, notify of results of the negotiation to a network node, receive information on at least one configuration from the network node, wherein the at least one configuration is, at least partly, based on the results of the negotiation, reconfigure the first communication device based on the at least one configuration and share resources, based on the executed reconfiguration.

According to one embodiment, the result of the negotiation comprises capabilities of both the communication devices.

According to one embodiment, the notification of results further comprises details of a sharing plan.

According to one embodiment, the information on the configuration is set to be valid for at least one of: a specific time, a number of DRX cycles and a duration of an ongoing session.

According to one embodiment, the communication device selects one of the at least one configuration.

According to one embodiment, information on which configuration the communication device shall use to the network node is provided.

According to one embodiment, the information on which configuration the communication device will use is provided, using a physical uplink control channel (PUCCH).

According to one embodiment, the notifying comprises a consolidating of the results on the negotiating on the resource sharing between the two communication devices.

According to another aspect, a network node for assisting a first communication device and a second communication device when sharing resources with each other, is suggested. The network node is configured to receive results on a negotiation on resource sharing between the two communication devices, determine at least one configuration, based on the provided results and to provide information on the configuration to at least one of the communication devices.

According to one embodiment, results of the negotiation is received from one of the communication devices, as consolidated results on the negotiation.

According to one embodiment, the received results of the negotiation comprises capabilities of both the communication devices.

According to one embodiment, the information on the configuration is determined to be valid on a temporary basis.

According to one embodiment, configuration information is determined to be valid for at least one of: a specific time, a number of DRX cycles and a session.

According to one embodiment, determining of the at least one configuration is based on at least one of: Radio Access Technology (RATs), bandwidth, battery and number of antennas.

According to one embodiment, providing results on the negotiation comprises providing information on capabilities of the communication devices.

According to one embodiment, the determining at least one configuration is determined based on at least one of: energy efficiency, needed bitrate and latency.

According to one embodiment, requesting further information on the negotiation from at least one of the communication devices, having required results on resource sharing.

According to one embodiment, comprising requesting for information on new capabilities According to one embodiment, providing the information on the configuration include providing details on a sharing plan.

According to one embodiment, providing the information on the configuration is based on at least one of: aligning paging and DRX configurations.

According to one embodiment, provide information from at least one of the communication devices indicating which configuration is presently active.

According to one embodiment, comprising providing information on which configuration to use, using a physical downlink control channel (PDCCH).

According to yet another embodiment, a computer program product comprising non transitory computer readable medium, having stored there on a computer program, such as the one mentioned above, is also suggested.

Generally, all terms used in the claims are to be interpreted according to their ordinary meaning in the technical field, unless explicitly defined otherwise herein. All references to “a/an/the element, apparatus, component, means, step, etc.” are to be interpreted openly as referring to at least one instance of the element, apparatus, component, means, step, etc., unless explicitly stated otherwise. The steps of any method disclosed herein do not have to be performed in the exact order disclosed, unless explicitly stated.

### BRIEF DESCRIPTION OF THE DRAWINGS

Aspects and embodiments are now described, by way of example, with reference to the accompanying drawings, in which:

FIG. 1 is a block scheme, illustrating two communication devices and a network node, configured for resource sharing between the communication devices, according to one embodiment.

FIG. 2 is a graph illustrating how resource usage can change in time between two communication devices.

FIG. 3 is a flow chart, illustrating a method executable at a communication device for sharing resources, according to one embodiment.

FIG. 4 is a flow chart illustrating a method executable at a network node for sharing resources, according to one embodiment.

FIG. 5 is a signalling scheme, illustrating two communication devices, and a network node, engaged in a process for sharing resource.

FIG. 6 is a schematic diagram, illustrating functional units of a communication device according to one embodiment.

FIG. 7 is an illustrating a block scheme of a communication device, according to another embodiment.

FIG. 8 is a schematic diagram, illustrating functional units of a network node according to one embodiment.

FIG. 9 is an illustrating a block scheme of a network node, according to another embodiment.

### DETAILED DESCRIPTION

The aspects of the present disclosure will now be described more fully hereinafter with reference to the accompanying drawings, in which certain embodiments of the invention are shown. These aspects may, however, be embodied in many different forms and should not be construed as limiting, rather, these embodiments are provided by way of example so that this disclosure will be thorough and complete, and to fully convey the scope of all aspects of invention to those skilled in the art. Like numbers refer to like elements throughout the description.

As already mentioned, temporary resource sharing between communication devices, involving only the communication devices sharing resources with each other, may have negative impact on the network performance, especially if done on a large scale. A communication device, temporarily acquiring additional resources, e.g. for the purpose of obtaining higher bitrate, may still not be able to make use of these additional resources, even if the available channel conditions are good and cell load is low, due to that the communication device is not scheduled for higher bit rate transmission by the network, or the resources may become available but after excessive delay and/or signalling between the communication device and the network.

Therefore, in order to be able, not only to share resources between communication devices, but to do so while maintaining a desired performance in a network, involvement of also the serving network into the resource sharing process is suggested.

What is disclosed herein therefore refer, not only to how the capability of a communication device can be changed dynamically, by sharing resources with one or more other device, but also that not only the devices, involved in the resource sharing process, are becoming aware of the upcoming change of capability, but also at least one network node, such as e.g. a gNB, to which at least one of the devices is connected. Such a network node will be able to have an impact on the resource sharing process, by, at least partly, controlling how configurations are adapted to the new scenario at one or more of the communication devices, involved in the resource sharing process.

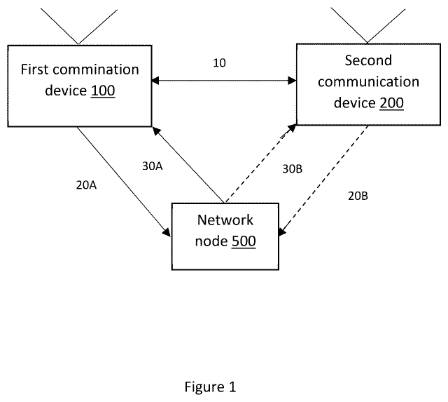

In embodiments presented herein a simplified method for sharing resources between two communication devices, involving also a network node, is described in further detail, with reference to FIG. 1, where two communication devices 100,200, here referred to as a first communication device 100 and a second communication device 200, are being physically or wirelessly connected to each other, after which the two communication devices 100,200 can start a procedure for changing capabilities dynamically. Once connected, at least one of the communication devices 100,200, determines that resource sharing is required. The communication devices 100,200 then negotiates with each other, as indicated with step 10, determining agreeable conditions for a resource sharing procedure, where such a negotiation includes exchanging their respective capabilities with each other, in order to determine if the two devices are capable of engaging in a required resource sharing process, and to what extent such a resource sharing process can be executed, such that e.g. if antenna or power amplifier resources can be shared. A network node 500 is capable of assisting the two communication devices 100,200 which are going to share resources, by having an impact on how the resource sharing process is executed. For such a purpose, the network node 500 is notified of the result of the negotiation by one of communication devices 100,200, here represented by the first communication device 100, as indicated with step 20A. Alternatively, the results, or parts of the result of the negotiation, can be notified by both the communication devices 100,200 to the network node 500. The network node 500 determines one or more configurations and provide 30A information on the determined one or more configurations to one or both devices 100,200. More specifically, if it is determined, at the network node 500, that both communication devices 100,200 need to be reconfigured, both devices 100,200 are notified of the respective one or more configurations, as indicated with step 30A and 30B, whereas if considered that only one of the communication devices, here the first communication device 100, require one or more configurations, only this communication device 100 is notified of such one or more configuration, as indicated with step 30A. The configurations can be provided using any type of available uplink channel.

Information on reconfiguration can, according to different embodiments have different meaning in different contexts. The mentioned information may, according to one embodiment comprise all information needed for a communication device to reconfigure according to a certain intent. According to an alternative embodiment, the information may comprise a link, allowing a respective communication device to access a relevant reconfiguration. According to yet another embodiment, the mentioned information may comprise a pointer or indicator, pointing to or indicating a specific reconfiguration, already accessible to or available, and selectable at the communication device.

Based on the information on the one or more configurations, one or both communication devices 100,200 reconfigures accordingly and can after that start sharing the resources.

Although not shown in FIG. 1, one or both communication devices 100,200 may inform network node 500, in further signalling, that the respective communication device 100,200 has changed configuration, using any suitable uplink channel, such as e.g. a physical uplink control channel (PUCCH), previously provided in the configuration information from the network node 500. Alternatively, or in combination, the network node 500, may provide a new configuration to one or both of the communication devices 100, 200 in a suitable downlink channel, such as e.g. a physical downlink control channel (PDCCH).

Although only described with two communication devices in FIG. 1, the described method can be applied with an arbitrary number of communication devices having established connection with at least one other communication device and the having direct or indirect connection with the network node.

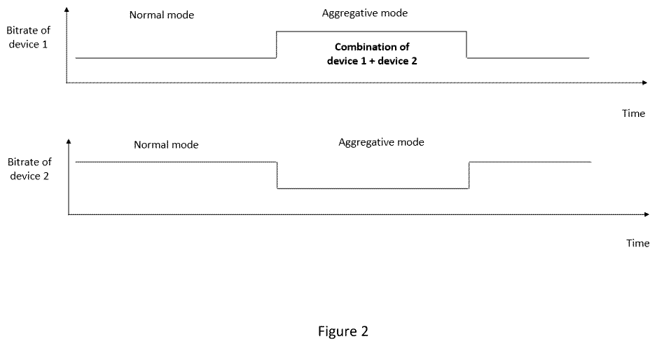

FIG. 2 is illustrating how a result of a negotiation between two communication devices, here device 1 and 2, can depend on bitrate requirements of the two devices. As indicated in the figure, device 1 first require relatively low bitrate before any capability sharing has been started, here indicated as normal mode. At this stage, device 1 has sufficient capabilities of its own and, thus, does not need to share any resources, whereas device 2, at the same time is applying a relatively high bitrate which may prohibit this device from sharing resources anyway. However, in a subsequent time interval, here indicated as aggregation mode, the demand for bit rate at device 1 increases, raising a demand for more resources. At the same time, the bitrate demand for device 2 happen to decrease, i.e. there is a perfect match for resource sharing between the two devices. If such a scenario can be predicted during or before negotiations between the two devices, such negotiations may result in temporary resource sharing during the aggregation mode, where this period is followed by both devices going back to normal mode at the end of the aggregation mode.

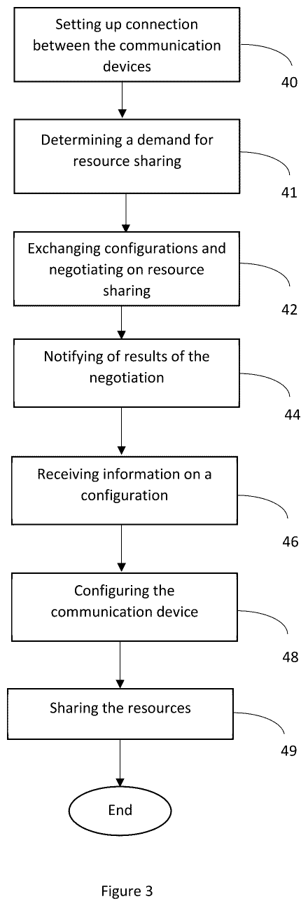

A sharing resource method, executed in a first communication device will now be described in further detail with reference to the flow chart of FIG. 3. In a first step 40, a connection is set up between the first communication device and a second communication device by being physically or wirelessly connected to each other, using any communication protocol to which the devices are adapted, such as e.g. Bluetooth, W-Fi, Near-Field Communication (NFC), Ultra-Wideband (UWB), LTE side-link communication, NR side-link communication or IEEE 802.15.4.

The first communication device then determines a demand for resource sharing as indicated in another step 41. The first communication device could e.g. come to the conclusion that it cannot, or predicts that is about to fail to reach its Quality of Service target (e.g. not enough bit rate). Then the connection is only established if there is a device that needs it. The first communication device exchanges its configurations and negotiates on resource sharing conditions with the second communication device, in order to determine if the two devices are capable of engaging in a resource sharing process, as indicated in another step 42. Based on the negotiation, the first communication device notifies the results to the network node as indicated in step 44. The results of the negotiations typically comprise conditions for the negotiated resource sharing, such as e.g. resources to be shared, time limits during which the sharing is to be executed. Such conditions may typically be comprised in what could be referred to as a sharing plan, agreed upon between the communication devices.

Alternatively, only the second communication device provides the results of the negotiation to the network node, thereby assuring that at least one of the two communication devices provides results to the network node.

In another step 46, the first communication device receives information on at least one configuration which the network node has determined, based on the results of the negotiations, after which the first communication device can reconfigure, according to the at least one configuration, provided from the network, if acquired, as indicated in step 48 and start to share the resources with the second communication device, as indicated in step 49.

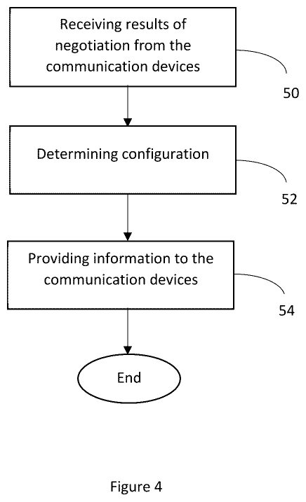

FIG. 4 is another flow chart, illustrating a method where a network node is assisting at least two communication devices sharing resources, according to the method as illustrated in FIG. 3. According to FIG. 4, the network node receives results of a negotiation between the communication devices about to share resources, as indicated in step 50. Based on the results, received from one or more of the communication devices, the network node is determining at least one acceptable configuration, as indicated in step 52. These configurations are typically provided on a temporary basis.

Apart from considering the results of the negotiations, the network node may determine configurations based on any type of network related information that it is aware of, including estimations on potential upcoming scenarios, when striving for achieving optimized network performance, also during resource sharing activities, such as the ones described herein. Such information may include one or more of e.g. available Radio Access Technology or technologies (RATs), information on bandwidth, battery usage, energy efficiency, bitrate latency, DRX cycles and/or patterns, data traffic, frequency intervals, MIMO layers, and DMRS port.

The network node then provides information on the one or more determined configuration to one or more of the communication devices, as indicated in step 54. The mentioned exchange of data may be executed in one respective step, as indicated in steps 50 and 54, or any of these events may, alternatively be executed in a plurality of steps, so that e.g., the network node can request further information from one or both of the communication devices, in case a first information exchange is found to be insufficient by the network node.

In case only one configuration is provided from the network node, it may be intended to be used for reconfiguration unconditionally by a receiving communication device, whereas, in case more than one configuration is provided, such configurations may be accompanied by conditions for when to be used for reconfiguration. Alternatively, the network node may provide information on different configurations when required.

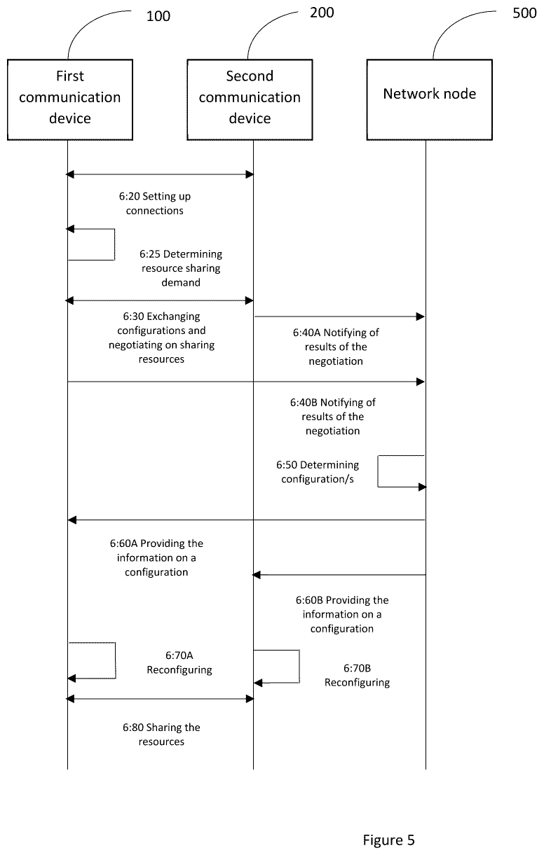

The sharing resource mechanism, as described herein, will now be described in further detail according to the signalling scheme of FIG. 5, which is illustrating a resource sharing process, executed between a first communication device 100 and a second communication device 200, assisted by a network node 500. Even though the given example is limited to describing two communication devices 100,200, it is to be understood that there could be more than two devices sharing resources with each other. According to FIG. 5, a connection is set up between the two communication devices 100, 200, when the communication devices 100,200 come in close proximity with each other, i.e. the devices establish wireless or physical connection with each other, according to any of the embodiments described above, as indicated in initial step 6:20.

Such a connection may e.g. be set up manually by a user, or automatically, e.g. when the devices come in close proximity of each other. In case connection set-up is executed automatically, such a set up will typically be initiated by one of the devices, once they are approaching within communication range of each other, whereas in case the connection set-up is executed manually, such a connection set-up can be executed by a user activating a relevant button or other actuation means on one of the devices, where such an activation will result in a connection set up if the relevant communication devices are within communication range of each other.

A demand for resource sharing is determined by one or both of the communication devices, 100,200, here the first communication device 100, once a connection has been set up as indicated in step 6:25. The process is proceeded with mutual exchange of configurations, and negotiations on sharing resources as indicated in step 6:30. The result of the negotiation is provided to the network node 500, either from both communication devices, as indicated in step 6:40A and 6:40B, or as a consolidated result, provided by one of the communication devices 100,200. The result of the negotiation comprises at least capabilities of both the communication devices. Alternatively, the result of the negotiation comprises further information, specifying on which conditions the negotiated resource sharing is to be executed such as e.g. duration of time, execution methods etc.

The network node 500 determines at least one configuration where such a determination is based at least on the acquired results on negotiations, possibly in combination with available network related information, which may have impact on network performance during the upcoming resource sharing procedure, as indicated in step 6:50, and provides the one or more determined configurations to the respective communication devices 100,200, here in steps 6.60A and 6.60B, respectively. In case a reconfiguration is required only in one of the communication devices 100,200, only this communication device will be provided with required information on the one or more configuration. The information on the reconfiguration can be set to be valid on a temporary basis. The first communication device 100 reconfigures according to the received information on the configuration, as indicated in step 6:70A, and the second communication device 200 reconfigures, as indicated in step 6:70B (if required) and then starts sharing the resources with the other communication device, as indicated in step 6:80. As already implied, information on other configurations may be provided from the network node 500 at later occasions during a resource sharing process, in case such changes are determined to be required by the network node 500.

The described method can be applied with an arbitrary number of communication devices having established connection with at least with one other communication device, where at least one of these devices need to be connected to the communication device, at least one communication device can also aggregate data from the other communication devices and share relevant information with the network node.

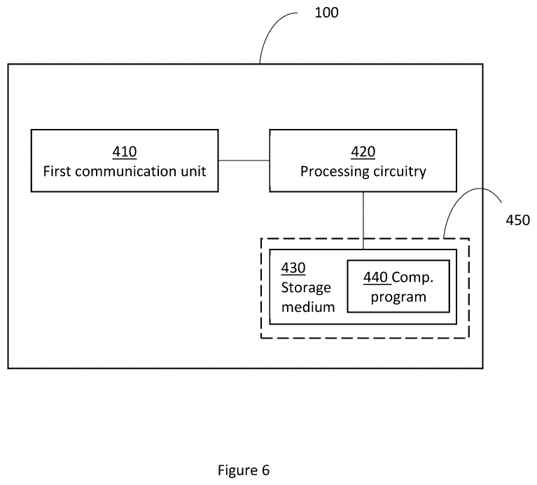

According to one aspect, a communication device 100, 200, capable of operating according to one or more of the embodiments described above may be configured as described in FIG. 6. The communication device 100, comprise processing circuitry 420, using any combination of one or more of a suitable central processing unit (CPU), multiprocessor, microcontroller, digital signal processor (DSP), etc., capable of executing software instructions stored in a computer program, e.g., in the form of a storage medium 430. The processing circuitry 420 may further be provided as at least one application specific integrated circuit (ASIC), or field programmable gate array (FPGA). Particularly, the processing circuitry 420 is configured to cause the communication device 100 to perform a set of operations, or actions, as disclosed above. For example, the storage medium 430 may store the set of operations, and the processing circuitry 420 may be configured to retrieve the set of operations from the storage medium 430 to cause the communication device 100 to perform the set of operations. The set of operations may be provided as a set of executable instructions. The processing circuitry 420 is thereby arranged to execute methods as herein disclosed. The storage medium 430 may also comprise persistent storage, which, for example, can be any single one or combination of magnetic memory, optical memory, solid state memory or even remotely mounted memory. The communication device 100 may further comprise a communication unit 410 configured to enable the communication device 100 to communicate with other communication devices and a network node. As such the communication unit 410 may comprise one or more transmitters and receivers, comprising analogue and digital components. Other components, as well as the related functionality, of the communication device 100 are omitted in order not to obscure the concepts presented herein.

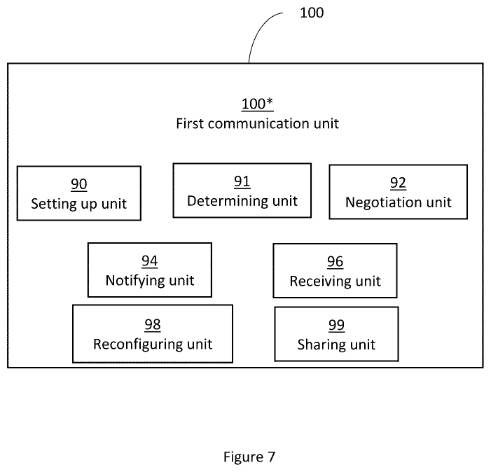

According to another aspect, a communication device 100, capable of operating according to one or more of the embodiments described above may be configures as described in FIG. 7. According to FIG. 7, the communication device 100 comprise: a setting up unit 90, configured to setting up connection with a another communication device 200 (not shown), via a communication unit 96A, corresponding to step 40 of FIG. 3; a determining unit 91, configured determine the demand for resource sharing, corresponding to step 41 of FIG. 3; a negotiation unit 92, configured to negotiate on resource sharing with another communication device, via the communication unit 96A, corresponding to step 42 of FIG. 3; a notifying unit 94, configured to notify the results of the negotiation to a network node 500 (not shown) to which the communication device is connected, via the communication unit 96, corresponding to step 44 of FIG. 3; a receiving unit 96, configured to receive information on at least one configuration from the network node 500, corresponding to step 46 of FIG. 3; a reconfiguring unit 98, configured to reconfigure the communication device 100, corresponding to step 48 of FIG. 3; and a sharing unit 99, configured to share resources based on the executed configuration, corresponding to step 49 of FIG. 3.

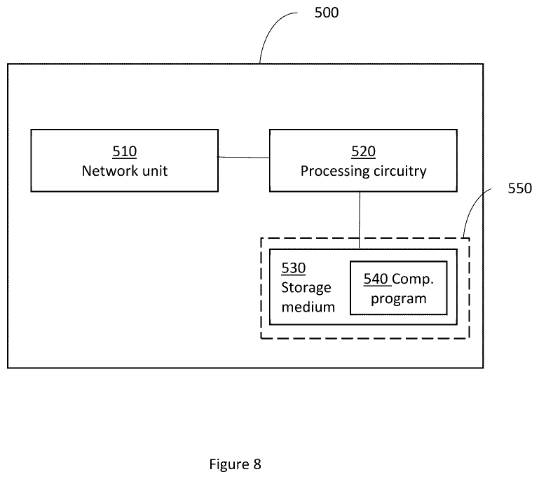

According to one aspect, a network node 500, capable of operating according to one or more of the embodiments described above may be configured as described in FIG. 8. The network node 500, comprise processing circuitry 520, using any combination of one or more of a suitable central processing unit (CPU), multiprocessor, microcontroller, digital signal processor (DSP), etc., capable of executing software instructions stored in a computer program, e.g., in the form of a storage medium 530. The processing circuitry 520 may further be provided as at least one application specific integrated circuit (ASIC), or field programmable gate array (FPGA). Particularly, the processing circuitry 520 is configured to cause the network node 500 to perform a set of operations, or actions, as disclosed above.

For example, the storage medium 530 may store the set of operations, and the processing circuitry 520 may be configured to retrieve the set of operations from the storage medium 530 to cause the network node 500 to perform the set of operations. The set of operations may be provided as a set of executable instructions. The processing circuitry 520 is thereby arranged to execute methods as herein disclosed. The storage medium 530 may also comprise persistent storage, which, for example, can be any single one or combination of magnetic memory, optical memory, solid state memory or even remotely mounted memory. The network node 500 may further comprise a network unit 510 configured to enable the network node 500 to communicate with other entities, functions, nodes, and devices, over suitable interfaces. As such the communication unit 510 may comprise one or more transmitters and receivers, comprising analogue and digital components. The processing circuitry 520 is configured to control the general operations of the network node 500 e.g., by exchanging data and control signals with any external entity via the network unit 510 and a suitable communications interface. Other components, as well as the related functionality, of the network node 500 are omitted in order not to obscure the concepts presented herein.

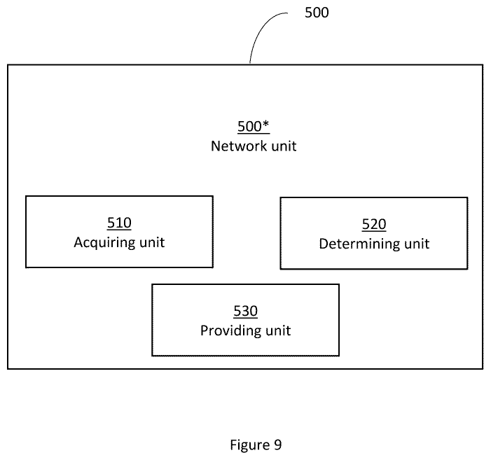

According to another aspect, a network node 100, capable of operating according to one or more of the embodiments described above may be configures as described in FIG. 9. According to FIG. 9, the network node 500 comprise: an acquiring unit 510, configured to acquire a result on a negotiation on resource sharing between communication devices, corresponding to step 50 of FIG. 4; a determining unit 520, configured to determine at least one configuration, based, at least partly on the acquired results, corresponding to step 52 of FIG. 4; and providing unit 530, configured to provide information on one or more configurations to at least one of the communication devices about to share resources with each other, corresponding to step 54 of FIG. 4.

The aspects of the present disclosure have mainly been described above with reference to a few embodiments. However, as is readily appreciated by a person skilled in the art, other embodiments than the ones disclosed above are equally possible within the scope of the invention, as defined by the appended patent claims. Thus, while various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following.

1. A method at a first communication device for sharing resources with a second communication device, the method comprising:
setting up a connection between the two communication devices;
negotiating in response to becoming aware of that resource sharing is required between the two communication devices, on resource sharing between the two communication devices;
notifying results of the negotiation to a network node; receiving information on at least one configuration from the network node, wherein the at least one configuration is, at least partly based on the results of the negotiation;
reconfiguring the first communication device based on the information on at least one configuration; and
sharing resources based on the executed reconfiguration.

2-12. (canceled)

13. A method at a network node for assisting a first communication device and a second communication device, sharing resources with each other, the method comprising:
receiving results on a negotiation on resource sharing between the two communication devices;
determining at least one configuration, based, at least partly, on the provided results; and
providing information on the at least one determined configuration to at least one of the communication devices.

27. A first communication device for sharing resources with a second communication device the first communication device being configured to:
set up a connection between the two communication devices;
negotiating in response to becoming aware of that resource sharing is required between the two communication devices, on resource sharing between the two communication devices;
notify of results of the negotiation to a network node; receive information on at least one configuration from the network node, wherein the at least one configuration is, at least partly, based on the results of the negotiation;
reconfigure the first communication device based on the at least one configuration; and
share resources based on the executed reconfiguration.

28. (canceled)

29. The first communication device according to claim 27, wherein the notification of results further comprises details of a sharing plan.

30. The first communication device according to claim 27, wherein the information on the configuration is set to be valid for at least one of: a specific time, a number of DRX cycles and a duration of an ongoing session.

31. The first communication device according to claim 27, wherein the communication device selects one of the at least one configuration.

32. The first communication device according to claim 27, further comprising providing information on which configuration the communication device shall use to the network node

33. The first communication device according to claim 27, wherein the providing of information on which configuration the communication device will use is provided, using a physical uplink control channel (PUCCH).

34. (canceled)

35. A network node for assisting a first communication device and a second communication device sharing resources, the network node being configured to:
receive results on a negotiation on resource sharing between the two communication devices;
determine at least one reconfiguration, based on the provided results; and
provide information on the reconfiguration to at least one of the communication devices.

36. The network node according to claim 35, wherein results of the negotiation is received from one of the communication devices, as consolidated results on the negotiation.

37. The network node according to claim 35, wherein the results of the negotiation comprises capabilities of both the communication devices.

38. (canceled)

39. The network node according to claim 35, wherein configuration information is determined to be valid for at least one of: a specific time, a number of DRX cycles and a session.

40. The network node according to claim 35, wherein the determining of the at least one configuration is based on at least one of:
Radio Access Technology (RATs), bandwidth, battery and number of antennas.

41. (canceled)

42. The network node according to claim 35, wherein the at least one configuration is determined based on at least one of: energy efficiency, needed bitrate and latency.

43-44. (canceled)

45. The network node according to claim 35, wherein providing the information on the configuration include providing details on a sharing plan.

46. The network node according to claim 35, wherein providing the information on the configuration is based on at least one of:
aligning paging and DRX configurations.

47. The network node according to claim 35, further comprising provide information from at least one of the communication devices indicating which configuration is presently active.

48. The network node according to claim 35, further comprising providing information on which configuration to use, using a physical downlink control channel (PDCCH).

49. (canceled)

50. A computer program product comprising non transitory computer readable medium, and a computer program comprising instructions which, when executed on at least one processor, cause the at least one processor to carry out operations comprising:
setting up a connection between the two communication devices;
negotiating, in response to becoming aware of that resource sharing is required between the two communication devices, on resource sharing between the two communication devices;
notifying results of the negotiation to a network node;
receiving information on at least one configuration from the network node, wherein the at least one configuration is, at least partly based on the results of the negotiation;
reconfiguring the first communication device based on the information on at least one configuration; and
sharing resources based on the executed reconfiguration.

51. (canceled)

52. A computer program product comprising non transitory computer readable medium, and a computer program comprising instructions which, when executed on at least one processor, cause the at least one processor to carry out operations comprising:
receiving results on a negotiation on resource sharing between the two communication devices;
determining at least one configuration, based, at least partly, on the provided results; and
providing information on the at least one determined configuration to at least one of the communication devices.
